(19) United States
(12) Patent Application Publication
(10) Pub. No.: US 2025/0391786 A1
(43) Pub. Date: Dec. 25, 2025

(54) PIEZOELECTRIC-BASED AUTHENTICATION FOR COUNTERFEIT PREVENTION IN MICROELECTRONICS

(71) Applicant: International Business Machines Corporation, Armonk, NY (US)

(72) Inventors: Viswas Purohit, East Amherst, NY (US); Aakrati Jain, Albany, NY (US); Kishan Jayanand, Albany, NY (US); Junwon Han, Loudonville, NY (US); Mary McGahay, Troy, NY (US); Nicholas Latham, Albany, NY (US); Sathyanarayanan Raghavan, Ballston Lake, NY (US); Nicholas Alexander Polomoff, Hopewell Junction, NY (US)

(21) Appl. No.: 18/751,829

(22) Filed: Jun. 24, 2024

(51) Int. Cl. H01L 23/00; H04L 9/32

(52) U.S. Cl. CPC H01L 23/573; H04L 9/3278

(57) ABSTRACT

A microelectronics device with anti-counterfeiting measures that includes an integrated circuit packaging and a piezoelectric element embedded on the integrated circuit packaging, such as on the surface of the integrated circuit packaging. The piezoelectric element is configured to generate a unique identification code in response to a series of controlled mechanical stresses being applied to the piezoelectric element. Due to the inherent variability in piezoelectric responses, there is a high degree of uniqueness in the identification code making them extremely difficult for counterfeiters to replicate. Furthermore, by applying different stress sequences, a multitude of unique identification codes can be generated from a single piezoelectric element providing an additional layer of security. In this manner, by embedding a piezoelectric element on the integrated circuit packaging, a highly secure, cost-effective, and difficult to replicate anti-counterfeiting technique for the microelectronics industry has been developed.

### TECHNICAL FIELD

The present disclosure relates generally to anti-counterfeiting techniques for microelectronic devices.

### BACKGROUND

Microelectronics is a subfield of electronics. Microelectronics relates to the study and manufacture (or microfabrication) of very small electronic designs and components, such as on the micrometer-scale or smaller. These devices are typically made from semiconductor materials. Many components of a normal electronic design are available in a microelectronic equivalent. These include transistors, capacitors, inductors, resistors, diodes, insulators, and conductors, which can all be found in microelectronic devices.

Unfortunately, counterfeiting is rampant in the microelectronics industry, which poses significant challenges to economic stability, and threatens the reliability and safety of electronic systems. As microelectronic devices become more ubiquitous and their functionalities more crucial, the issue of counterfeiting becomes increasingly serious. Counterfeit microelectronic components can lead to system failures, resulting in significant financial losses, potential harm to consumers, and erosion of trust in manufacturers.

### SUMMARY

In one embodiment of the present disclosure, a method for preventing counterfeiting of microelectronic devices comprises embedding a piezoelectric element on an integrated circuit packaging, where the piezoelectric element is configured to generate a unique identification code in response to a series of controlled mechanical stresses being applied to the piezoelectric element.

In another embedment of the present disclosure, a method for preventing counterfeiting of microelectronic devices comprises applying a series of controlled mechanical stresses to a piezoelectric element embedded on an integrated circuit packaging. The method further comprises receiving a response from the piezoelectric element to the applied series of controlled mechanical stresses. The method additionally comprises converting the response into a unique identifier.

Furthermore, in one embodiment of the present disclosure, a microelectronic device comprises an integrated circuit packaging. The microelectronic device further comprises a piezoelectric element embedded on the integrated circuit packaging. Furthermore, the piezoelectric element is configured to generate a unique identification code in response to a series of controlled mechanical stresses being applied to the piezoelectric element.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIGS. 1A-1C illustrate an embodiment of the present disclosure of a microelectronics device with a piezoelectric element embedded on an integrated circuit packaging in accordance with an embodiment of the present disclosure;

FIG. 1D illustrates a piezoelectric element with two electrical terminals in accordance with an embodiment of the present embodiment;

FIG. 1E illustrates the piezoelectric element being connected to a measurement structure in accordance with an embodiment of the present disclosure;

FIG. 2A illustrates applying controlled mechanical stresses to the piezoelectric element which generates a unique identification code, such as in the form of a series of voltage levels, measured by the measurement structure in accordance with an embodiment of the present disclosure;

FIG. 2B illustrates the piezoelectric element generating a unique identification code based on a series of applied controlled mechanical stresses in accordance with an embodiment of the present disclosure; and

FIG. 3 is a flowchart of a method for preventing the counterfeiting of microelectronic devices in accordance with an embodiment of the present disclosure.

### DETAILED DESCRIPTION

As stated above, microelectronics is a subfield of electronics. Microelectronics relates to the study and manufacture (or microfabrication) of very small electronic designs and components, such as on the micrometer-scale or smaller. These devices are typically made from semiconductor materials. Many components of a normal electronic design are available in a microelectronic equivalent. These include transistors, capacitors, inductors, resistors, diodes, insulators, and conductors, which can all be found in microelectronic devices.

Unfortunately, counterfeiting is rampant in the microelectronics industry, which poses significant challenges to economic stability, and threatens the reliability and safety of electronic systems. As microelectronic devices become more ubiquitous and their functionalities more crucial, the issue of counterfeiting becomes increasingly serious. Counterfeit microelectronic components can lead to system failures, resulting in significant financial losses, potential harm to consumers, and erosion of trust in manufacturers.

Counterfeiting involves misrepresenting the actual quality of the item with intent to defraud or deceive the purchaser. Examples of counterfeiting, such as counterfeited microelectronic devices, include unauthorized copies, a part in which the materials used or its performance has changed without notice, a substandard component misrepresented by the supplier, produced or distributed in violation of intellectual property rights, a copy or substitute without legal right or authority to do so, or one whose material, performance, or characteristics are knowingly misrepresented.

Examples of counterfeited parts, such as counterfeited parts in microelectronic devices, include parts re-topped and/or remarked to disguise parts differing from those offered by the original part manufacturer, defective parts scraped by the original part manufacture, previously used parts salvaged from scrapped assemblies, devices which have been refurbished but represented as a new product, etc.

Existing anti-counterfeiting measures have not been entirely successful in preventing this problem due to a number of reasons, including, but not limited to, their limited security features, ease of replication by counterfeiters, and the fast pace of technological advances which often outstrips the development of these measures.

There are several known solutions to the problem of counterfeiting in the microelectronics industry. However, each has its limitations. For example, holograms are commonly used on product packaging for their visual appeal and difficulty to replicate accurately. However, with advancing technology, counterfeiters have also become better at duplicating holograms.

Another solution to counterfeiting in the microelectronics industry is the use of radio frequency identification (RFID) tags. RFID tags can store a product's unique information and can be read wirelessly. However, RFID tags can be intercepted and copied. Furthermore, there is a significant cost for adding an RFID tag to every component or product.

Barcodes or QR codes have been used in an attempt to prevent counterfeiting microelectronic devices. These codes can be printed onto product packaging or the product itself. However, they can be easily replicated and do not offer a high level of security.

Another example is the use of cryptographic authentication, which has been used to prevent counterfeiting microelectronic devices. Cryptographic methods can provide robust security, but they require significant computational resources, and can be vulnerable to various attacks if not implemented correctly.

Recently, unique material characteristics (e.g., rare earth materials) have been leveraged to deter counterfeiting microelectronic devices. However, such a method adds significant cost and requires advanced detection methods.

Marking is another example in an attempt to prevent counterfeiting of microelectronic devices. For example, integrated circuits (ICs) can be marked with laser marking, ink dot, or chemical etching. However, these markings can be removed or altered.

Furthermore, track and trace systems have been utilized in an attempt to prevent counterfeiting of microelectronic devices. These systems monitor the movement of components through the supply chain. However, they require extensive infrastructure, and can be cost-prohibitive in some instances.

All these methods have their own limitations, such as ease of replication, interception and duplication, cost, resource intensive, vulnerability to attacks, limited security features, and required infrastructure.

For example, techniques, such as holograms, barcodes, and QR codes, can be easily replicated with modern printing and scanning technologies, making them less reliable for authentication purposes.

Technologies, such as RFID tags, can be intercepted and cloned, presenting a security risk.

Some solutions, such as RFID tags, cryptographic methods, unique material characteristics, and track and trace systems, can be expensive to implement, particularly for lower-cost components.

Cryptographic authentication methods can require significant computational resources and can slow down systems.

Cryptographic systems can be vulnerable to various attacks if not properly implemented.

Laser marking, ink dot, or chemical etching on ICs can be removed or altered, and do not offer a high level of security.

Furthermore, solutions, such as track and trace systems, require extensive infrastructure and can be cost-prohibitive.

Hence, there is not currently a means for a highly secure, cost-effective, and difficult to replicate anti-counterfeiting technique for the microelectronics industry.

The embodiments of the present disclosure provide a means for preventing the counterfeiting of microelectronic devices that addresses the deficiencies of prior anti-counterfeiting techniques by embedding a piezoelectric element on the integrated circuit packaging (e.g., semiconductor integrated circuit), where the piezoelectric element generates a unique identification code in response to a series of controlled mechanical stresses being applied to the piezoelectric element. Each known applied stress results in a unique and repeatable electric charge that is sequenced due to the intrinsic properties of the piezoelectric material and the applied stress pattern. The response of the piezoelectric element to the applied controlled mechanical stresses is converted into a unique identifier, such as a binary code, thereby effectively creating a distinctive “fingerprint” which is only shared between the manufacturer and the supplier/purchaser. Due to the inherent variability in piezoelectric responses, there is a high degree of uniqueness in the identification code making them extremely difficult for counterfeiters to replicate. Furthermore, by applying different stress sequences, a multitude of unique identification codes can be generated from a single piezoelectric element providing an additional layer of security. In this manner, by embedding a piezoelectric element on the integrated circuit packaging, where the piezoelectric element generates a unique identification code in response to a series of controlled mechanical stresses being applied to the piezoelectric element, a highly secure, cost-effective, and difficult to replicate anti-counterfeiting technique for the microelectronics industry has been developed. A further description of these and other features will be provided below.

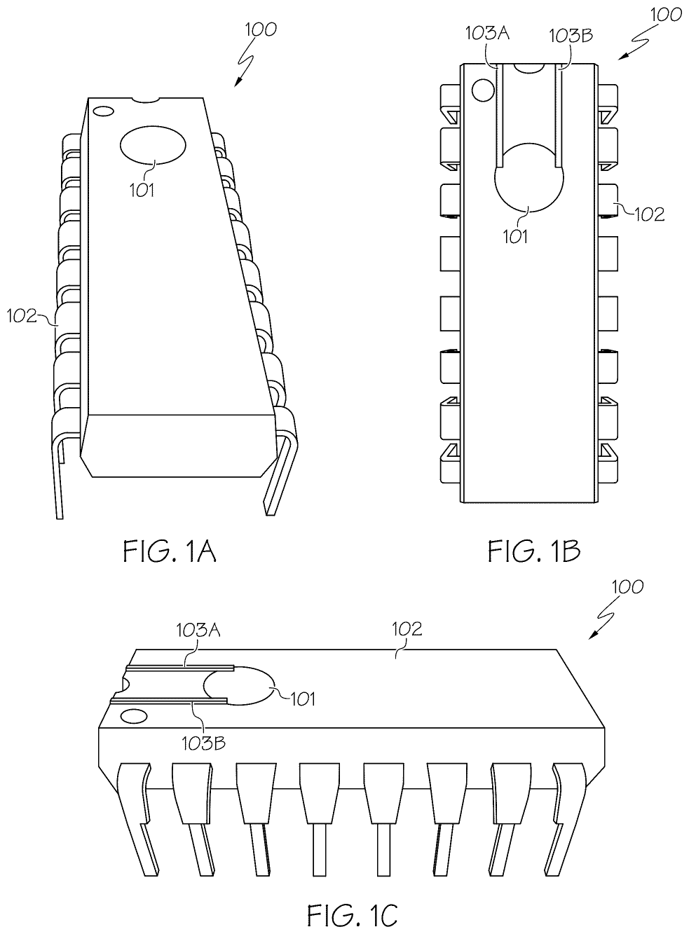

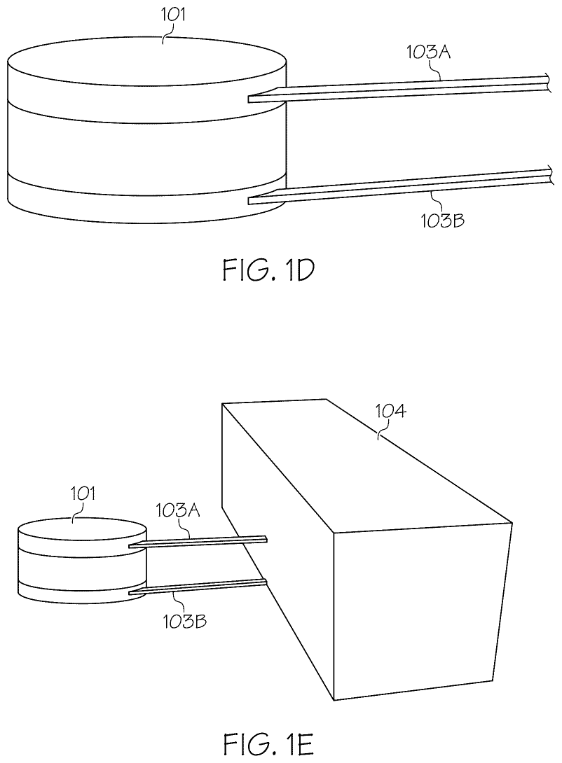

Referring now to the Figures in detail, FIGS. 1A-1C illustrate an embodiment of the present disclosure of a microelectronics device with a piezoelectric element embedded on an integrated circuit packaging in accordance with an embodiment of the present disclosure.

As shown in FIGS. 1A-1C, a microelectronic device 100 includes a piezoelectric element 101 embedded on an integrated circuit packaging (e.g., semiconductor integrated circuit) 102. For example, piezoelectric element 101 may be embedded on the surface of integrated circuit packaging 102 as shown in FIGS. 1A-1C. A piezoelectric element 101, as used herein, is a device that can generate an electric charge (energy carried by the electric charge is measured as voltage) when force is applied to it. Materials that can be used to form piezoelectric element 101, include, but are not limited to, quartz, Rochelle salt, tourmaline, lead zirconate titanate, barium titanate, zinc oxide, aluminum nitride, polyvinylidene fluoride, and polyvinylidene difluoride-trifluoroethylene.

Integrated circuit packaging 102, as used herein, is a compact electronic device made up of multiple interconnected electronic components, such as transistors, resistors, and capacitors. These components are etched onto a small piece of semiconductor material, such as silicon. The components are then wired together with interconnects that are layered on top of the semiconductor. The result is a small, monolithic chip that can be as small as a few square millimeters.

Furthermore, as shown in FIGS. 1A-1C, piezoelectric element 101 may be in the form of a disc. In one embodiment, piezoelectric element 101 is in the form of a sheet. In one embodiment, piezoelectric element 101 is integrated into integrated circuit packaging 102 during the manufacturing process, which is known to one skilled in the art. Furthermore, piezoelectric element 101 may be integrated into integrated circuit packaging 102 during the final stages of the chip packaging thereby not requiring significant alterations to the existing manufacturing process.

In one embodiment, piezoelectric element 101 is exposed to the outside of integrated circuit packaging 102 via two electrical terminals 103A-103B, such as at the front and back of the chip packaging, to allow readouts, such as voltage readouts, as shown in FIGS. 1B and 1C. A further illustration of piezoelectric element 101 with two electrical terminals is provided in FIG. 1D.

Referring to FIG. 1D, FIG. 1D illustrates piezoelectric element 101 with two electrical terminals 103A-103B in accordance with an embodiment of the present embodiment. In one embodiment, such terminals 103A-103B are made from metal or other conductive materials.

In one embodiment, a standard circuit containing a buffer with an extremely high input impedance may be used to obtain the final output of piezoelectric element 101 as illustrated in FIG. 1E.

FIG. 1E illustrates piezoelectric element 101 being connected to a measurement structure in accordance with an embodiment of the present disclosure.

As shown in FIG. 1E, piezoelectric element 101 is connected to measurement structure 104 via electrical terminals 103A-103B. Measurement structure 104 may correspond to a standard circuit containing a buffer with an extremely high input impedance which may be used to obtain the final output of piezoelectric element 101. For example, measurement structure 104 may be used to measure the output voltage of piezoelectric element 101. In one embodiment, measurement structure 104 is utilized by the manufacturer and the supplier/purchaser to identify the unique identification code generated by piezoelectric element 101, such as in the form of a series of voltage levels.

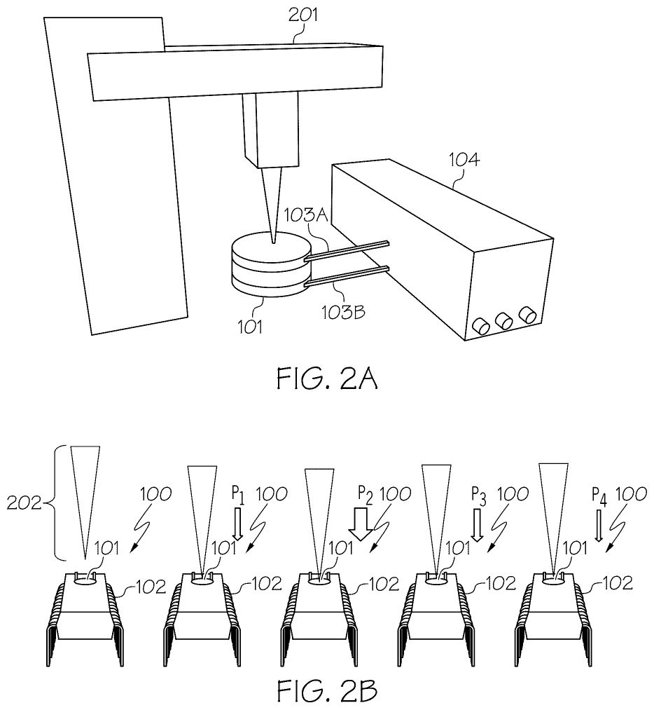

A discussion regarding the generation of such unique identification codes by piezoelectric element 101 in response to applied controlled mechanical stresses is provided below in connection with FIGS. 2A-2B.

FIG. 2A illustrates applying controlled mechanical stresses to piezoelectric element 101 which generates a unique identification code, such as in the form of a series of voltage levels, measured by measurement structure 104 in accordance with an embodiment of the present disclosure.

As shown in FIG. 2A, a pressure generating device 201, such as low-pressure generating device, such as a piston cylinder, subjects piezoelectric element 101 to a series of controlled mechanical stresses. Piezoelectric element 101 produces a corresponding sequence of electric charges, where the energy carried by the electric charges is measured as a voltage. Such a sequence of electric charges corresponds to a pattern of responses that is intrinsically linked to the piezoelectric properties of the material of piezoelectric element 101 and the mechanical stress sequence applied by pressure generating device 201.

In one embodiment, such a pattern of responses, such as in the form of voltage levels, is measured by measurement structure 104 thereby effectively decoding the output of piezoelectric element 101 into a unique identification code, such as in a binary representation, thereby effectively creating a distinctive “fingerprint” which is only shared between the manufacturer and the supplier/purchaser.

A further illustration of piezoelectric element 101 generating a unique identification code is provided in FIG. 2B.

FIG. 2B illustrates piezoelectric element 101 generating a unique identification code based on a series of applied controlled mechanical stresses in accordance with an embodiment of the present disclosure.

As shown in FIG. 2B, pressure generating device 201 may apply a series of controlled mechanical stresses in the form of a series of pressures. For example, pressure generating device 201 applies a series of pressures designated as P₁, P₂, P₃, and P₄. FIG. 2B also illustrates the scenario in which pressure generating device 201 is not applying a pressure (see element 202).

In one embodiment, the series of pressures applied by pressure generating device 201 may correspond to sequence of forces of pressure, which are known only between the manufacturer and the supplier/purchaser. For example, the force of pressure P₁ may correspond to 1 Newton (N), the force of pressure P₂ may correspond to 2 N, the force of pressure P₃ may correspond to 3 N, and the force of pressure P₄ may correspond to 4 N as illustrated in the table (Table 1) shown below.

TABLE 1
Sequence of Applied Pressure and Output Voltage

| | Amount of | Measured Voltage Outputted |
|---|---|---|
| Applied Pressure | Applied Pressure | by Piezoelectric Element |
| P₁ | Force of 1 N | 3 V |
| P₂ | Force of 2 N | 8 V |
| P₃ | Force of 3 N | 4 V |
| P₄ | Force of 4 N | 1 V |

Based on a particular sequence of controlled mechanical stresses being applied to piezoelectric element 101, piezoelectric element 101 generates a unique identification code, such as in the form of a series of voltage levels. For example, as illustrated in Table 1, the sequence of applying mechanical stresses P₁, P₂, P₃, and P₄ results in piezoelectric element 101 generating the sequence of output voltage levels of 3 V, 8 V, 4 V, and 1 V.

Such a sequence is only known between the manufacturer and the supplier/purchaser, such as in the form of a pressure versus voltage sheet which may be in a similar form as shown in Table 1. For example, the manufacturer may provide a sequence of applied pressures which correspond to a sequence of voltage values. These values form the “secret code” of piezoelectric element 101.

The supplier/purchaser, upon receiving the microelectronic device (e.g., microelectronic device 100) with the embedded piezoelectric element 101, applies the same sequence of pressures to piezoelectric element 101 and measures the responses, such as in the form of voltage levels, using measurement structure 104. If these measurements match the manufacturer's provided responses (e.g., voltage values), such as within a specified range, the supplier/purchaser confirms the authenticity of the microelectronic device (e.g., microelectronic device 100).

Furthermore, by allowing the generation of multiple unique codes from a single piezoelectric element 101, there is an additional layer of security. This is achieved by applying different sequences of pressures to piezoelectric element 101.

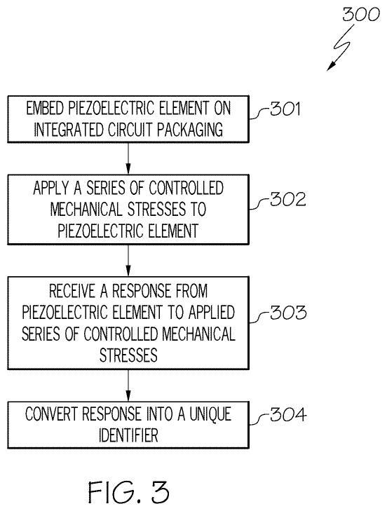

A discussion regarding a method for preventing the counterfeiting of microelectronic devices is provided below in connection with FIG. 3.

FIG. 3 is a flowchart of a method 300 for preventing the counterfeiting of microelectronic devices in accordance with an embodiment of the present disclosure.

Referring to FIG. 3, in conjunction with FIGS. 1A-1E and 2A-2B, in step 301, piezoelectric element 101 is embedded on integrated circuit packaging 102, where piezoelectric element 101 is configured to generate a unique identification code in response to a series of controlled mechanical stresses being applied to piezoelectric element 101. For example, piezoelectric element 101 may be embedded on the surface of integrated circuit packaging 102 as shown in FIGS. 1A-1C.

As discussed above, piezoelectric element 101, as used herein, is a device that can generate an electric charge (energy carried by the electric charge is measured as voltage) when force is applied to it.

Materials that can be used to form piezoelectric element 101, include, but are not limited to, quartz, Rochelle salt, tourmaline, lead zirconate titanate, barium titanate, zinc oxide, aluminum nitride, polyvinylidene fluoride, and polyvinylidene difluoride-trifluoroethylene.

Furthermore, as stated above, integrated circuit packaging 102, as used herein, is a compact electronic device made up of multiple interconnected electronic components, such as transistors, resistors, and capacitors. These components are etched onto a small piece of semiconductor material, such as silicon. The components are then wired together with interconnects that are layered on top of the semiconductor. The result is a small, monolithic chip that can be as small as a few square millimeters.

Additionally, as shown in FIGS. 1A-1C, piezoelectric element 101 may be in the form of a disc. In one embodiment, piezoelectric element 101 is in the form of a sheet. In one embodiment, piezoelectric element 101 is integrated into integrated circuit packaging 102 during the manufacturing process, which is known to one skilled in the art. Furthermore, piezoelectric element 101 may be integrated into integrated circuit packaging 102 during the final stages of the chip packaging thereby not requiring significant alterations to the existing manufacturing process.

In one embodiment, piezoelectric element 101 is exposed to the outside of integrated circuit packaging 102 via two electrical terminals 103A-103B, such as at the front and back of the chip packaging, to allow readouts, such as voltage readouts, as shown in FIGS. 1B and 1C. A further illustration of piezoelectric element 101 with two electrical terminals 103A-103B is provided in FIG. 1D. In one embodiment, such terminals 103A-103B are made from metal or other conductive materials.

After piezoelectric element 101 is embedded on integrated circuit packaging 102, piezoelectric element 101 generates a unique identification code in response to a series of controlled mechanical stresses being applied to piezoelectric element 101 as discussed in the following steps.

In step 302, a series of controlled mechanical stresses (e.g., pressures P₁, P₂, P₃, and P₄) are applied to piezoelectric element 101.

As stated above, pressure generating device 201, such as low-pressure generating device, such as a piston cylinder, subjects piezoelectric element 101 to a series of controlled mechanical stresses as shown in FIG. 2A.

In step 303, a response to the applied series of controlled mechanical stresses is received from piezoelectric element 101.

As discussed above, piezoelectric element 101 produces a corresponding sequence of electric charges, where the energy carried by the electric charges is measured as a voltage. Such a sequence of electric charges corresponds to a pattern that is intrinsically linked to the piezoelectric properties of the material of piezoelectric element 101 and the mechanical stress sequence applied by pressure generating device 201.

In step 304, the response provided by piezoelectric element 101 is converted into a unique identifier.

As stated above, in one embodiment, the response to the applied series of controlled mechanical stresses is in the form of a sequence of electric charges, where the energy carried by the electric charges is measured as a voltage. In one embodiment, the response in the form of a sequence of electric charges is converted into a sequence of voltage levels measured by measurement structure 104. Such a sequence of voltage levels corresponds to the unique identifier thereby effectively creating a distinctive “fingerprint” which is only shared between the manufacturer and the supplier/purchaser.

A further illustration of piezoelectric element 101 generating a unique identification code is provided in FIG. 2B.

As shown in FIG. 2B, pressure generating device 201 may apply a series of controlled mechanical stresses in the form of a series of pressures. For example, pressure generating device 201 applies a series of pressures designated as P₁, P₂, P₃, and P₄.

In one embodiment, the series of pressures applied by pressure generating device 201 may correspond to sequence of forces of pressure, which are known only between the manufacturer and the supplier/purchaser. For example, the force of pressure P₁ may correspond to 1 Newton (N), the force of pressure P₂ may correspond to 2 N, the force of pressure P₃ may correspond to 3 N, and the force of pressure P₄ may correspond to 4 N as illustrated in the table (Table 1) shown below.

TABLE 1
Sequence of Applied Pressure and Output Voltage

| | Amount of | Measured Voltage Outputted |
|---|---|---|
| Applied Pressure | Applied Pressure | by Piezoelectric Element |
| P₁ | Force of 1 N | 3 V |
| P₂ | Force of 2 N | 8 V |
| P₃ | Force of 3 N | 4 V |
| P₄ | Force of 4 N | 1 V |

Based on a particular sequence of controlled mechanical stresses being applied to piezoelectric element 101, piezoelectric element 101 generates a unique identification code, such as in the form of a series of voltage levels. For example, as illustrated in Table 1, the sequence of applying mechanical stresses P₁, P₂, P₃, and P₄ results in piezoelectric element 101 generating the sequence of output voltage levels of 3 V, 8 V, 4 V, and 1 V.

Such a sequence is only known between the manufacturer and the supplier/purchaser, such as in the form of a pressure versus voltage sheet which may be in a similar form as shown in Table 1. For example, the manufacturer may provide a sequence of applied pressures which correspond to a sequence of voltage values. These values form the “secret code” of piezoelectric element 101.

The supplier/purchaser, upon receiving the microelectronic device (e.g., microelectronic device 100) with the embedded piezoelectric element 101, applies the same sequence of pressures to piezoelectric element 101 and measures the responses, such as in the form of voltage levels, using measurement structure 104. If these measurements match the manufacturer's provided responses (e.g., voltage values), such as within a specified range, the supplier/purchaser confirms the authenticity of the microelectronic device (e.g., microelectronic device 100).

Furthermore, by allowing the generation of multiple unique codes from a single piezoelectric element 101, there is an additional layer of security. This is achieved by applying different sequences of pressures to piezoelectric element 101.

In this manner, a robust, hard to replicate, and cost-effective anti-counterfeiting strategy is achieved by leveraging the unique properties of piezoelectric materials to generate distinct codes for microelectronic device authentication. For example, the inherent variability in piezoelectric responses, which generate a high degree of uniqueness in the identification codes, makes them extremely difficult for counterfeiters to replicate. Moreover, by applying different stress sequences, a multitude of unique identification codes can be generated from a single piezoelectric element thereby providing an additional layer of security.

Some of the notable advantages of the piezoelectric-generated code strategy of the present disclosure over existing anti-counterfeiting solutions in the microelectronics industry include uniqueness and being difficult to replicate. Due to the inherent variability in piezoelectric responses, the generated identification codes offer a high degree of uniqueness, making replication by counterfeiters exceedingly difficult. This contrasts with other existing anti-counterfeiting techniques, such as barcodes or holograms, which can be more easily replicated.

Furthermore, another advantage of the piezoelectric-generated code strategy of the present disclosure over existing anti-counterfeiting solutions in the microelectronics industry is generating multiple unique identifiers. For instance, in response to applying different stress sequences, a single piezoelectric element is able to generate a multitude of unique codes thereby adding an additional layer of security. Such a feature is not present in existing anti-counterfeiting solutions, such as holograms, RFID tags, or barcodes.

Additionally, another advantage of the piezoelectric-generated code strategy of the present disclosure over existing anti-counterfeiting solutions in the microelectronics industry is low cost and simple implementation. In comparison to existing anti-counterfeiting solutions, such as cryptographic methods, RFID tags, and track-and-trace systems, the approach of the present disclosure is mechanically activated, requiring less sophisticated hardware or software, thus making it cost-effective.

Furthermore, another advantage of the piezoelectric-generated code strategy of the present disclosure over existing anti-counterfeiting solutions in the microelectronics industry is requiring less infrastructure. Unlike existing anti-counterfeiting solutions, such as track-and-trace systems, that require extensive infrastructure, the piezoelectric technique of the present disclosure can be incorporated into existing manufacturing processes thereby reducing infrastructure demands.

Additionally, another advantage of the piezoelectric-generated code strategy of the present disclosure over existing anti-counterfeiting solutions in the microelectronics industry is being robust and hard to replicate. The unique physical properties leveraged in the technique of the present disclosure make it a hard to replicate anti-counterfeiting strategy as opposed to more easily duplicated techniques, such as marking integrated circuits.

Furthermore, the principles of the present disclosure improve the technology or technical field involving anti-counterfeiting techniques for microelectronic devices.

As discussed above, counterfeiting is rampant in the microelectronics industry, which poses significant challenges to economic stability, and threatens the reliability and safety of electronic systems. As microelectronic devices become more ubiquitous and their functionalities more crucial, the issue of counterfeiting becomes increasingly serious. Counterfeit microelectronic components can lead to system failures, resulting in significant financial losses, potential harm to consumers, and erosion of trust in manufacturers. Counterfeiting involves misrepresenting the actual quality of the item with intent to defraud or deceive the purchaser. Examples of counterfeiting, such as counterfeited microelectronic devices, include unauthorized copies, a part in which the materials used or its performance has changed without notice, a substandard component misrepresented by the supplier, produced or distributed in violation of intellectual property rights, a copy or substitute without legal right or authority to do so, or one whose material, performance, or characteristics are knowingly misrepresented. Examples of counterfeited parts, such as counterfeited parts in microelectronic devices, include parts re-topped and/or remarked to disguise parts differing from those offered by the original part manufacturer, defective parts scraped by the original part manufacture, previously used parts salvaged from scrapped assemblies, devices which have been refurbished but represented as a new product, etc. Existing anti-counterfeiting measures have not been entirely successful in preventing this problem due to a number of reasons, including, but not limited to, their limited security features, ease of replication by counterfeiters, and the fast pace of technological advances which often outstrips the development of these measures.

Embodiments of the present disclosure improve such technology by embedding a piezoelectric element on the integrated circuit packaging (e.g., semiconductor integrated circuit), where the piezoelectric element generates a unique identification code in response to a series of controlled mechanical stresses being applied to the piezoelectric element. Each known applied stress results in a unique and repeatable electric charge that is sequenced due to the intrinsic properties of the piezoelectric material and the applies stress pattern. The response of the piezoelectric element to the applied controlled mechanical stresses is converted into a unique identifier, such as a binary code, thereby effectively creating a distinctive “fingerprint” which is only shared between the manufacturer and the supplier/purchaser. Due to the inherent variability in piezoelectric responses, there is a high degree of uniqueness in the identification code making them extremely difficult for counterfeiters to replicate. Furthermore, by applying different stress sequences, a multitude of unique identification codes can be generated from a single piezoelectric element providing an additional layer of security. In this manner, by embedding a piezoelectric element on the integrated circuit packaging, where the piezoelectric element generates a unique identification code in response to a series of controlled mechanical stresses being applied to the piezoelectric element, a highly secure, cost-effective, and difficult to replicate anti-counterfeiting technique for the microelectronics industry has been developed. Furthermore, in this manner, there is an improvement in the technical field involving anti-counterfeiting techniques for microelectronic devices.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for preventing counterfeiting of microelectronic devices, the method comprising:
embedding a piezoelectric element on an integrated circuit packaging, wherein said piezoelectric element is configured to generate a unique identification code in response to a series of controlled mechanical stresses being applied to said piezoelectric element.

2. The method as recited in claim 1, wherein said piezoelectric element is embedded on a surface of said integrated circuit packaging.

3. The method as recited in claim 1, wherein said series of controlled mechanical stresses corresponds to a sequence of forces, wherein said piezoelectric element generates a sequence of electric charges in response to said series of controlled mechanical stresses.

4. The method as recited in claim 3, wherein said sequence of electric charges is measured as a sequence of voltage levels.

5. The method as recited in claim 4, wherein said sequence of voltage levels corresponds to said unique identification code.

6. The method as recited in claim 1, wherein said unique identification code authenticates said integrated circuit packaging.

7. The method as recited in claim 1, wherein a material used to form said piezoelectric element comprises one of the following in the group consisting of: quartz, Rochelle salt, tourmaline, lead zirconate titanate, barium titanate, zinc oxide, aluminum nitride, polyvinylidene fluoride, and polyvinylidene difluoride-trifluoroethylene.

8. A method for preventing counterfeiting of microelectronic devices, the method comprising:
applying a series of controlled mechanical stresses to a piezoelectric element embedded on an integrated circuit packaging;
receiving a response from said piezoelectric element to said applied series of controlled mechanical stresses; and
converting said response into a unique identifier.

9. The method as recited in claim 8, wherein said series of controlled mechanical stresses corresponds to a sequence of forces.

10. The method as recited in claim 8, wherein said response to said applied series of controlled mechanical stresses is in a form of a sequence of electric charges.

11. The method as recited in claim 10, wherein said sequence of electric charges is measured as a sequence of voltage levels.

12. The method as recited in claim 11, wherein said sequence of voltage levels corresponds to said unique identifier.

13. The method as recited in claim 8, wherein a material used to form said piezoelectric element comprises one of the following in the group consisting of: quartz, Rochelle salt, tourmaline, lead zirconate titanate, barium titanate, zinc oxide, aluminum nitride, polyvinylidene fluoride, and polyvinylidene difluoride-trifluoroethylene.

14. A microelectronic device, comprising:
an integrated circuit packaging; and
a piezoelectric element embedded on said integrated circuit packaging;
wherein said piezoelectric element is configured to generate a unique identification code in response to a series of controlled mechanical stresses being applied to said piezoelectric element.

15. The microelectronic device as recited in claim 14, wherein said series of controlled mechanical stresses corresponds to a sequence of forces, wherein said piezoelectric element generates a response to said series of controlled mechanical stresses in a form of a sequence of electric charges.

16. The microelectronic device as recited in claim 15, wherein said sequence of electric charges is measured as a sequence of voltage levels.

17. The microelectronic device as recited in claim 16, wherein said sequence of voltage levels corresponds to said unique identification code.

18. The microelectronic device as recited in claim 14, wherein said piezoelectric element comprises two electrical terminals to allow readouts.

19. The microelectronic device as recited in claim 14, wherein said piezoelectric element is connected to a measurement structure via electrical terminals.

20. The microelectronic device as recited in claim 14, wherein a material used to form said piezoelectric element comprises one of the following in the group consisting of: quartz, Rochelle salt, tourmaline, lead zirconate titanate, barium titanate, zinc oxide, aluminum nitride, polyvinylidene fluoride, and polyvinylidene difluoride-trifluoroethylene.
